(19) United States
(12) Patent Application Publication
(10) Pub. No.: US 2003/0135444 A1
(43) Pub. Date: Jul. 17, 2003

(54) Multiple award optimization

(76) Inventors: Nachiappan Annamalai, Pittsburgh, PA (US); Vijay Raghuraman, Pittsburgh, PA (US); Christopher Smith, Wexford, PA (US); Benjamin S. Snyder, Bethel Park, PA (US)

Correspondence Address: MORGAN, LEWIS & BOCKIUS LLP, 1701 Market Street, Philadelphia, PA, 19103, US

(21) Appl. No.: 10/047,766

(22) Filed: Jan. 15, 2002

(51) Int. Cl. G06F 17/60

(52) U.S. Cl. 705/37

(57) ABSTRACT

A method for multiple award optimization bidding in online auctions, including providing, by the buyer, a price ceiling and a tolerance for a resource, soliciting bids, having a unit price and quantity, from suppliers, validating the bids if the bids meet a set of rules, generating an optimal solution, having an optimal quantity and an optimal unit price from at least one supplier, comparing the optimal unit price to a compare value, and replacing the compare value with the optimal unit price if the optimal unit price is less than the compare value.

### FIELD OF THE INVENTION

The invention relates generally to conducting online electronic auctions, and in particular, real-time, interactive optimization used for decision making.

### BACKGROUND OF THE INVENTION

Procurement and Sourcing Models

It is believed that procurement of goods and services has traditionally involved high transaction costs. The cost of finding and qualifying potential bidders has been particularly high. The advent of electronic commerce has introduced new methods of procurement that lower some of the transaction costs associated with procurement. Electronic procurement, and in particular business-to-business electronic procurement, matches buyers and suppliers and facilitates transactions that take place on networked processors.

Supplier-bidding auctions for products and services defined by a buyer have been developed. In a supplier-bidding auction, bid prices may start high and move downward in reverse-auction format as suppliers interact to establish a closing price. The auction marketplace is often one-sided, i.e., one buyer and many potential suppliers. It is believed that, typically, the products being purchased are components or materials. “Components” may mean fabricated tangible pieces or parts that become part of assemblies of durable products. Example components include gears, bearings, appliance shelves, or door handles. “Materials” may mean bulk quantities of raw materials that are further transformed into product. Example materials include corn syrup or sheet steel.

Industrial buyers may not purchase one component at a time. Rather, they may purchase whole families of similar components in order to achieve economic means of scale. These items may therefore be grouped into a single lot. Suppliers in industrial auctions may provide unit price quotes for all line items in a lot. Auction Process

In many types of business transactions, price may not be the sole parameter upon which a decision is made. For example, in the negotiations for a supply contract, a buyer may compare various proposals not only on the basis of price but also on the basis of the non-price characteristics of non-standard goods, the location of the supplier, the reputation of the supplier, etc. In a typical business-to-business situation, a plurality of parameters may be considered in combination with the supplier's price proposal.

In these situations, purchasers may negotiate with each supplier independently because multi-parameter bids may not be readily compared. Actual comparisons by the purchaser may be based on a combination of subjective and objective weighting functions. Bidders may not have access to information on the buyer-defined weighting functions. At most, bidders may be selectively informed (at their disadvantage) of aspects of other competing bids. The limited communication of information between bidders may limit the potential of true competition between the bidders. The absence of competition may lower the likelihood that the bidders approach their true walk-away bid. Further, the manual weighting process may be time consuming and subject to inconsistency from one application to the next.

### SUMMARY OF THE INVENTION

The invention provides a method for multiple award optimization bidding in online auctions. This method includes providing, by the buyer, a price ceiling and a tolerance for a resource, soliciting bids from suppliers, validating the bids if the bids meet a set of rules, generating an optimal solution with the validated bids, comparing an optimal unit price to a compare value, and replacing the compare value with the optimal unit price if the optimal unit price is less than the compare value. The bids have a unit price and a quantity, and the optimal solution has an optimal quantity and an optimal unit price from one or more suppliers.

The invention provides another method for multiple award optimization bidding in online auctions. This method includes providing, by the buyer, a price ceiling and a tolerance for a resource, soliciting bids from suppliers, accepting a most recent bid from a bidder, calculating a total cost for the most recent bid, comparing the unit price for the most recent bid against the price ceiling, checking the quantity of the most recent bid against a quantity of a previous bid from the bidder and the total cost of the most recent bid against a previous total cost of the bidder, evaluating the quantity of the most recent bid against a quantity of at least one other supplier's bid and the unit price of the most recent bid against a unit price of at least one other supplier's bid, and rejecting the bid if the unit price of the most recent bid is not greater than the price ceiling, the quantity of the most recent bid is less than the quantity of the previous bid from the bidder and the total cost of the most recent bid is greater than the previous total cost of the bidder, or the quantity of the most recent bid is equal to the quantity of current bids from other suppliers and the unit price of the most recent bid is equal to the unit price of the current bids from other suppliers. The method further includes determining a decision variable for the current bids and the most recent bid if the most recent bid is not rejected, generating an optimal solution from a lowest overall combination of the most recent bid and the current bids, comparing an optimal unit price to a compare value, evaluating whether the decision variable of the most recent bid matches an optimal parameter, replacing the compare value with the optimal unit price if the optimal unit price is not equal to the compare value and the decision variable of the most recent bid matches the optimal parameter, notifying the suppliers, in real time, that the most recent bid is in the optimal solution if the decision variable matches the optimal parameter, and accepting the most recent bid if the decision variable does not match the optimal parameter. The bids have the unit price, the quantity, and the total cost, and the optimal solution has the optimal quantity, the optimal unit price, and the optimal parameter. The optimal quantity is a sum of quantities from the optimal solution set of bids, and the optimal unit price is an average of the unit price from the solution set of bids.

The invention also provides a method for bidders to determine an optimal bid. This method includes providing, by the buyer, a price ceiling and a tolerance for a resource, receiving a bid from a supplier, inputting a value for a new unit price or a new quantity, generating an optimal bid using the inputted value, and supplying a corresponding value necessary to reach the optimal bid or a no feasible solution result.

The invention also provides a system for multiple award optimization bidding in online auctions. The system includes a database for receiving and storing a price ceiling and a tolerance from a buyer and bids from suppliers for a resource and software for validating the bids and generating an optimal solution. The bids have a unit price and a quantity, and the optimal solution has an optimal quantity, an optimal unit price, and an optimal parameter.

The invention further provides a machine readable medium for multiple award optimization bidding in online auctions. This machine readable medium includes a first machine readable code that receives and stores a price ceiling and a tolerance from a buyer and bids from suppliers for a resource, a second machine readable code that validates the bids, and a third readable code that generates an optimal solution. The bids have a unit price and a quantity, and the optimal solution has an optimal quantity, an optimal unit price and an optimal parameter.

### BRIEF DESCRIPTION OF THE DRAWINGS

The accompanying drawings, which are incorporated herein and constitute a part of this specification, illustrate the presently preferred embodiments of the invention and, together with the general description given above and the detailed description given below, serve to explain the features of the invention.

In the drawings:

FIG. 1A is a flow diagram of a request for quotation in an auction;

FIG. 1B is a flow diagram of a bidding process in an auction;

FIG. 1C is a flow diagram of a contract award following an auction;

FIG. 2 is a schematic illustration of communications links between the coordinator, the buyer, and the suppliers in an auction;

FIG. 3 is a block flow diagram of a first embodiment of the method of the invention;

FIG. 4 is a block flow diagram of a second embodiment of the method of the invention;

FIG. 5 is a block flow diagram of a third embodiment of the method of the invention; and

FIG. 6 is a schematic illustration of auction software and computers hosting that software in an auction.

### DETAILED DESCRIPTION OF THE PREFERRED EMBODIMENTS

Reference will now be made in detail to the preferred embodiments of the present invention, examples of which are illustrated in the accompanying drawings. It is to be understood that the Figures and descriptions of the present invention included herein illustrate and describe elements that are of particular relevance to the present invention, while eliminating, for purposes of clarity, other elements found in typical auction systems and computer networks.

The invention provides a method for selecting an optimal balance between any measurable, or quantifiable, values. The invention is designed to create a market of competition in business transactions that traditionally could not take advantage of natural auction dynamics. The method is particularly applicable to online auctions where bidders submit bids to an auction coordinator electronically during the auction process. The method provides optimal solutions with an n-dimensional array of bidding in parameters, such as a two-dimensional array of volume versus cost. The buyer may choose the best optimal solution for his particular situation based on the desired number of suppliers and the direct cost, or total cost, to purchase the lots from those suppliers.

The following description of the features of the present invention is presented in the context of downward-based online industrial auctions. However, as would be appreciated by one of ordinary skill in the relevant art, these inventive features could also be applied in the context of upward-based online auctions as well.

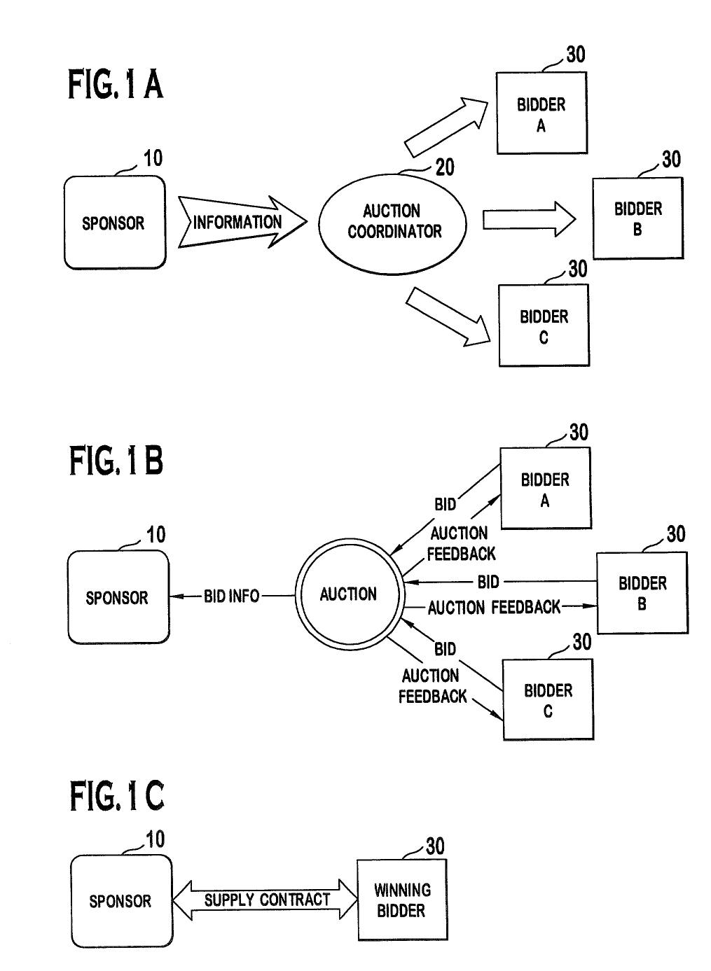

The basic process for a purchaser sponsored supplier-bidding or reverse auction, as conducted by the assignee of the present invention, is described below with reference to FIG. 1. FIG. 1 illustrates the functional elements and entities involved in setting up and conducting a typical supplier-bidding auction. FIG. 1A illustrates the creation of an auctioning event, FIG. 1B illustrates the bidding during an auction, and FIG. 1C illustrates results after completion of a successful auction.

In the supplier-bidding reverse auction model, the product or service to be purchased is, preferably, defined by the sponsor, or originator, 10 of the auction, as shown in FIG. 1A. Alternatively, the buyer may set up all or some of its own bidding events and find its own suppliers. The sponsor 10 could run the events through a market operations center, which is a facility where auctions are monitored and participants receive assistance, or run the events as a self-service option. Software may be provided to the sponsor 10 through a plug-in program or similar means. If the sponsor 10 decides to use the auctioning system of the present invention to procure products or services, the sponsor 10 may provide information to an auction coordinator 20. That information may include information about incumbent suppliers and historic prices paid for the products or services to be auctioned, for example. Preferably, the sponsor 10 also works with the auction coordinator 20 to define the products and services to be purchased in the auction and lot the products and services appropriately so that desired products and services can be procured using optimal auction dynamics. A specification may then be prepared for each desired product or service, and a Request for Quotation (“RFQ”) may be generated for the auction.

Next, the auction coordinator 20 may identify potential suppliers 30, preferably with input from the sponsor 10, and invite the potential suppliers 30 to participate in the upcoming auction. The suppliers 30 that are selected to participate in the auction may become bidders 30 and may be given access to the RFQ, typically through an RFQ in a tangible form, such as on paper or in an electronic format.

As shown in FIG. 1B, during a typical auction, bids are made for lots. Bidders 30 may submit actual unit prices for all line items within a lot, however, the competition in an auction is typically based on the aggregate value bid for all line items within a lot. The aggregate value bid for a lot may, therefore, depend on the level and mix of line item bids and the quantity of goods or services that are offered for each line item. Thus, bidders 30 submitting bids at the line item level may actually be competing on the lot level. During the auction, the sponsor 10 may monitor the bidding as it occurs. For example, as shown in Graphs 1, 2, and 3, the sponsor 10 may view a consolidated feedback curve, cost curves at various time states, where the stars represent the optimal suppliers, and commodity pricing trends, respectively.

[symbol]

[symbol]

[symbol]

Bidders 30 may also be given market feedback during the auction so that they may bid competitively. One method of feedback includes ranking, which is described in detail in copending patent applications, application Ser. No. 09/753,073, application Ser. No. 09/710,097, and application Ser. No. 09/490,868, which are incorporated herein by reference in their entirety. Bidders 30 may view the market feedback in the form of graphs, charts, or other similar means. For example, in Graph 4, the bidder 30 may view his own cost curve or he may have access to all bidder 30 cost curves.

[symbol]

After the auction, the auction coordinator 20 may analyze the auction results with the sponsor 10. The sponsor 10 may conduct final qualification of the low bidding supplier or suppliers 30. The sponsor 10 may furthermore retain the right not to award business to a low bidding supplier 30 based on final qualification or other business concerns. As shown in FIG. 1C, a supply contract may be drawn up for the winning bidder 30 and executed based on the results of the auction.

The auction may be conducted electronically between bidders 30 at their respective remote sites and the auction coordinator 20 at its site. Alternatively, instead of the auction coordinator 20 managing the auction at its site, the sponsor 10 may perform auction coordinator tasks at its site.

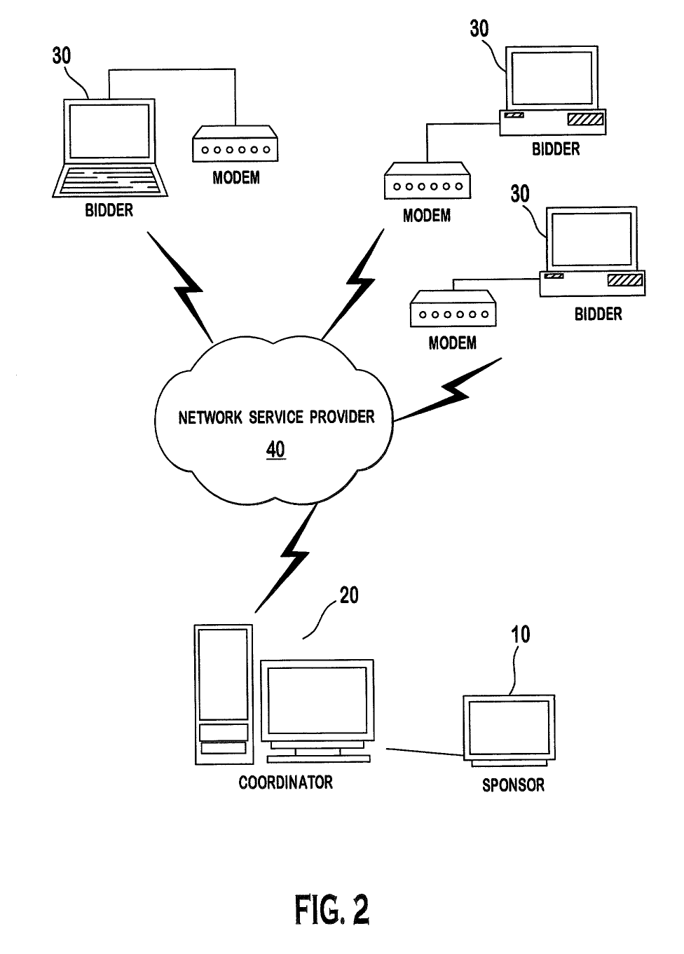

Information may be conveyed between the coordinator 20 and the bidders 30 via any communications medium. As shown in FIG. 2, bidders 30 may be connected to the auction through the Internet via a network service provider 40 accessed, for example, through a dial-up telephone connections. Alternatively, sponsors 10 and bidders 30 may be coupled to the auction by communicating directly with the auction coordinator 20 through a public switched telephone network, a wireless network, or any other connection.

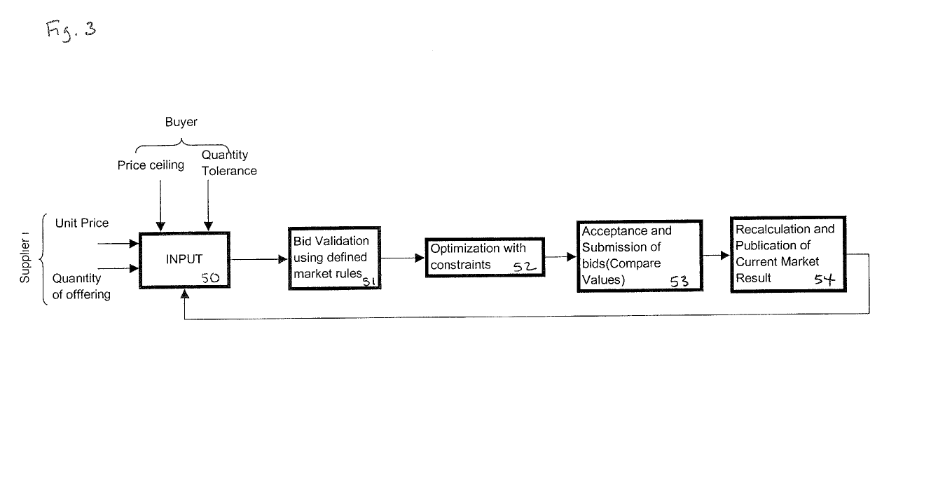

In a first embodiment, as shown in FIG. 3, at the beginning of the auction, various input is provided in step 50. The input includes a price ceiling, where a supplier may not bid on less than a particular percent of a quantity, and a tolerance for a resource from the buyer and solicited bids from suppliers. The input may also include a quantity floor, where the supplier should submit a bid on a minimum percentage of a quantity. The required parameters input by the buyer may be turned on or off throughout the auction and may also be changed. The bids have a unit price and a quantity. The unit may be a requirement, percentage, set-up quantity, or lot. The resource may be any goods or services desired by the buyer. In step 51, the bids are validated if the bids meet a set of rules, or constraints. These rules may be defined by the buyer and preferably, include requirements that the average cost improves and the supplier improves its previous bid. Preferably, the validated bids will be accepted, whereas the bids that do not meet the set of rules will be rejected.

An optimal solution is generated with the validated bids in step 52. The optimal solution has an optimal quantity, an optimal unit price, and an optimal parameter. The optimal parameter is a binary variable with a value of 1 (e.g., Aᵢ=1, where i represents the bidder). In step 53, the optimal unit price is compared to a compare value, and the compare value is replaced with the optimal unit price if the optimal unit price is not equal to the compare value. Preferably, the suppliers are notified of the optimal solution, or current market result, in step 54.

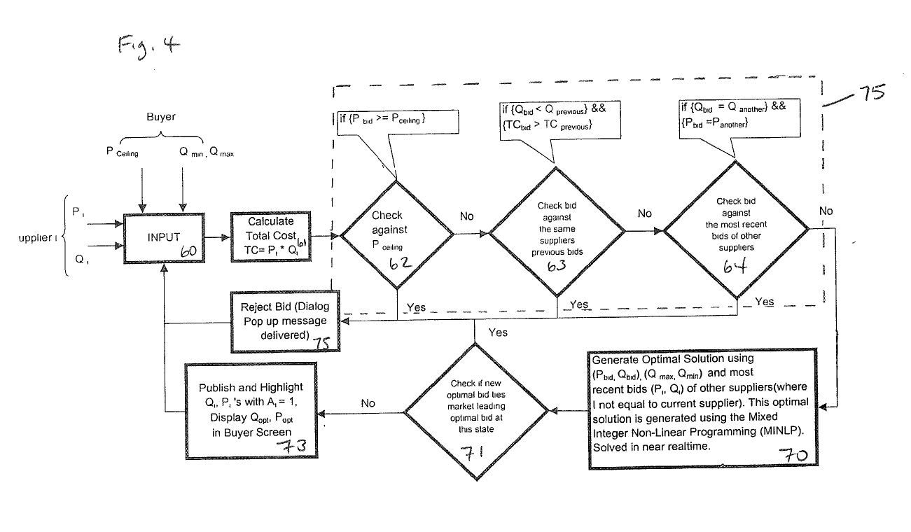

In a second embodiment, as shown in FIG. 4, a price ceiling (“P _{Ceiling}”) and a tolerance for a resource from the buyer and solicited bids from suppliers are received in step 60. The tolerance, which may be changed by the buyer at any time during the auction, has a minimum and maximum acceptable quantity (“Q ₘᵢₙ, Q ₘₐₓ”)(e.g., Q ₘᵢₙ=50 and Q ₘₐₓ=100), and the bids have a unit price and a quantity (“Pᵢ, Q ᵢ”) (e.g., Pᵢ=$5.00/unit and Qᵢ=70, where i represents the i'th supplier). If one or more bids submitted do not meet the minimum acceptable quantity, the bids will not be accepted. The total quantity from the bids included in the optimal solution must also not exceed the maximum acceptable quantity. The bid may have specific values or it may have range of values. For each accepted bid, a total cost (“TC”) may be calculated from the unit price and the quantity in step 61.

In this embodiment, a most recent bid that is accepted from a bidder among the suppliers is examined through the optimization process. The most recent bid is first subject to a multiple-step validation process 65, or a filter. In step 62, the unit price for the most recent bid is compared against the price ceiling. If the unit price of the most recent bid (“P _{bid}”) is less than the price ceiling (“P _{ceiling}”), then the most recent bid proceeds to the next step of the validation process. If the unit price of the most recent bid is greater than or equal to (or not less than) the price ceiling, then the most recent bid is rejected in step 75 and the bidder is notified of the rejection. In step 63, the quantity of the most recent (“Q _{bid}”) bid is checked against a quantity of a previous bid (“Q ₚᵣₑᵥᵢₒᵤₛ”) from the bidder and the total cost of each bid (“TC _{bid}”) against a previous total cost of the bidder (“TC ₚᵣₑᵥᵢₒᵤₛ”). If the quantity of the most recent bid is less than the quantity of the previous bid from the bidder and the total cost of the most recent bid is greater than a previous total cost of the bidder, then the most recent bid is rejected in step 75. If, however, the quantity of the most recent bid is not less than the quantity of the previous bid from the bidder and the total cost of the most recent bid is not greater than a previous total cost of the bidder, the most recent bid proceeds to step 64 of the validation process. In step 64, the quantity of the most recent bid is evaluated against a quantity of at least one other supplier's bid (“Q ₐₙₒₜₕₑᵣ”) that has been validated, or accepted, in the previous steps, and the unit price of the most recent bid is evaluated against a unit price of at least one other supplier's bid (“P ₐₙₒₜₕₑᵣ”). If the quantity of the most recent bid is equal to the quantity of current bids from other suppliers and the unit price of the most recent bid is equal to the unit price of the current bids from other suppliers, then the most recent bid is rejected in step 75. If the quantity of the most recent bid is not equal to the quantity of current bids from other suppliers and the unit price of the most recent bid is not equal to the unit price of the current bids from other suppliers, then the most recent bid will be validated.

Once the most recent bid is validated, an optimal solution will be generated in step 70. First, a decision variable for the current bids, or highest bids, from the other suppliers and the most recent bid are determined. Preferably, non-linear programming is used to determine a binary variable of 0 or 1, where 1 is an optimal parameter. The non-linear programming for a global optimal solution obtained through a pre-set bid validation may be as follows:

MIN=(SUM(Pᵢ*Qᵢ*Aᵢ)/SUM(Qᵢ*Aᵢ))+SUM(Aᵢ*M)−SUM(Qᵢ*N)

where: M=constant for minimization of suppliers (supplier penalty cost);

N=constant for maximization of quantity (quantity factor);

SUM(Qᵢ*Aᵢ)<=Q ₘₐₓ;

SUM(Qᵢ*Aᵢ)>=Q ₘᵢₙ; and

Aᵢ={0 or 1}.

For each Aᵢ, where i represents the bid number, a value of 0 or 1 is calculated. If Aᵢ=1, then the bid will be included in the optimal solution.

A binary variable matching the optimal parameter may also be assigned to a bid if the buyer prefers to include bids from a preferred supplier in the optimal solution. A value of 1 signifies that the most recent bid matches constraints of the auction. Then, an optimal solution is generated from a lowest overall combination of the most recent bid and the current bids. Preferably, the unit price, quantity, and tolerance are considered in the calculation. The optimal solution may also be limited by allowing only a minimum or maximum number of suppliers, which would be decided by the buyer, preferably, before the auction commences. The optimal solution has an optimal quantity (Q ₒₚₜ) and an optimal unit price (P ₒₚₜ), where the optimal quantity is a sum of quantities from an optimal solution set of bids and the optimal unit price is an average of the unit price from the solution set of bids. These values may be represented as follows:

Q ₒₚₜ=SUM(Qᵢ*Aᵢ); and

P ₒₚₜ=SUM(Pᵢ*Qᵢ*Aᵢ)/Q ₒₚₜ.

The optimal solution may also be based on payment terms, cost, percentage, lead time, discounts, and other parameters quantifiable as numbers.

If an optimal solution is generated, the process proceeds to step 71, where the optimal unit price is compared to a compare value (“P _{opt previous}[1+bid decrement]”) calculated in step 70. This compare value is the leading optimal solution before the most recent bid was submitted, and it is less than the previous optimal unit price from a bid submitted earlier (“P _{opt previous}[1−bid decrement]”). If the optimal unit price is less than the compare value and the most recent bid decision variable (“A _{current bid}”) matches the optimal parameter, which is 1, then the compare value is replaced with the optimal solution calculated in step 70. The suppliers will then be notified that the most recent bid is part of the optimal solution in step 73. Otherwise, the most recent bid is rejected, or denied, in step 75. This process continues with each new bid from a supplier. The process proceeds in real time, and the optimal solutions are displayed to the buyer on a continuous basis. The displays to the buyer and the suppliers are, preferably, refreshed with each new bid. The displays may also be in a format of a ranked ordering of submitted bids in accordance with the optimal solution.

In a third embodiment, steps 61 to 64 may be eliminated, and in step 60, the supplier's input may include a unit price and a quantity from the i'th supplier's j'th bid (“Pᵢⱼ, Qᵢⱼ”). In step 70 the non-linear programming may be as follows:

MIN=(SUM(Qᵢⱼ*Pᵢⱼ*Aᵢⱼ)/SUM(Qᵢⱼ*Aᵢⱼ))+SUM(Aᵢⱼ*M)−SUM(Qᵢⱼ*N)

where: SUM(Qᵢⱼ*Aᵢⱼ)>=Qₘᵢₙ,

SUM(Qᵢⱼ*Aᵢⱼ)<=Qₘₐₓ; and

SUM(Aᵢⱼ≦1).

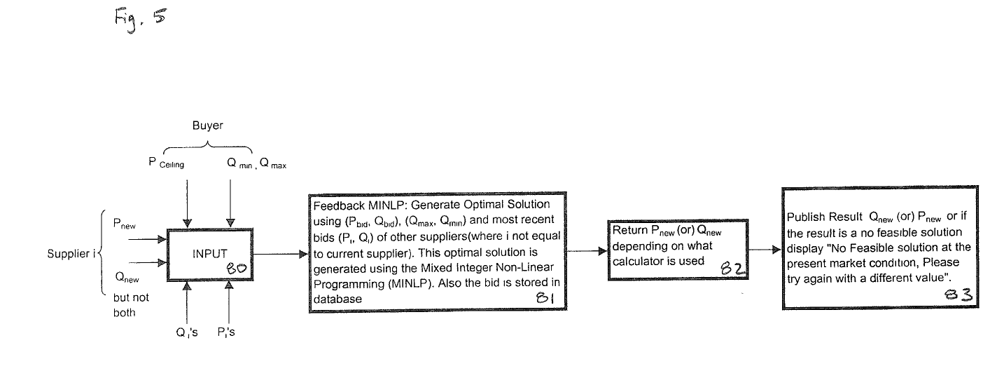

In a fourth embodiment, as shown in FIG. 5, a supplier may determine an optimal bid, which may become an optimal bid, to be included in the optimal solution. In step 80, input from the buyer and suppliers is received. The buyer provides a price ceiling (“P _{ceiling}”) and a tolerance, or maximum and minimum quantity (“Qₘᵢₙ, Qₘₐₓ”) for a resource and the suppliers provide bids with a unit price and a quantity (“Pᵢ, Q ᵢ”). The suppliers know the optimal bids in the optimal solution, so, preferably, the suppliers' next bids will replace an existing optimal bid in the optimal solution. With the two parameters of unit price and quantity, it may be difficult to provide a optimal bid. In this embodiment, a supplier may calculate a new bid by inputting either a new unit price (“P_{new}”) or a new quantity (“Q_{new}”) into a processor. In step 81, an optimal bid is generated using the inputted value of the new unit price or the new quantity.

The non-linear programming for input of Q_{new} may be as follows:

MIN U=SUM(Qᵢ*Pᵢ*Aᵢ)/SUM(Qᵢ*Aᵢ)

where: i≠current supplier;

i=1 to n suppliers;

SUM(Qᵢ*Aᵢ)≦Qmax;

SUM(Qᵢ*Aᵢ)≧Qmin; and

Aᵢ={0 or 1}.

We then solve for P_{new} as follows:

((P_{new}*Q_{new})+(SUM(Qᵢ*Pᵢ*Aᵢ)/SUM(Qᵢ*Aᵢ)))<P _{previous optimal}[1-Bid decrement]

Alternatively, the non-linear programming for input of P_{new} may be as follows:

MIN V=(P_{new}*Q_{new})+(SUM(Qᵢ*Pᵢ*Aᵢ)/SUM(Qᵢ*Aᵢ))

where: i≠current supplier

i=1 to n suppliers;

SUM (Qᵢ*Aᵢ)≦Qmax;

SUM (Qᵢ*Aᵢ)≧Qmin;

Aᵢ={0 or 1}; and

MIN V<P _{previous optimal}(1−Bid decrement).

The processor will calculate the corresponding value of the new quantity or the new unit price necessary to reach the optimal bid in step 82. The corresponding value will be provided to the supplier, or if a corresponding value cannot be calculated, a no feasible solution result will be provided in step 83.

In an example of the multiple award optimization auction, a buyer may want to purchase a volume of a commodity. The buyer may choose to accept a minimum of 60 units and a maximum of 100 units from all suppliers. The suppliers submit bids that include the % of offering and the price per the % of offering. If supplier 1 offers a bid 1 of 70%, or 70 units, at $5 per unit, at that time, the supplier 1 is notified that the bid 1 is optimal. Then, supplier 2 submits a bid for 30%, or 30 units, at $6 per unit and is also notified that bid 2 is optimal. At this time, the buyer may view a display of the optimal bids, where the total quantity is 100%, or 100 units, the total cost is $530, and the average unit cost is $5.3 per unit. Now, if supplier 3 wants to submit an optimal bid, supplier 3 may use the processor to calculate either a fixed % of offering or the price per % of offering. If supplier 3 uses 65 as the fixed % of offering, the processor will notify supplier 3 that the corresponding value of $4 per % must also be offered for the offer of 65 to become the optimal bid. If a bid 3 with those parameters is offered, then bid 3 will become part of the optimal solution, and bid 1 or bid 2 may be deleted from the optimal solution.

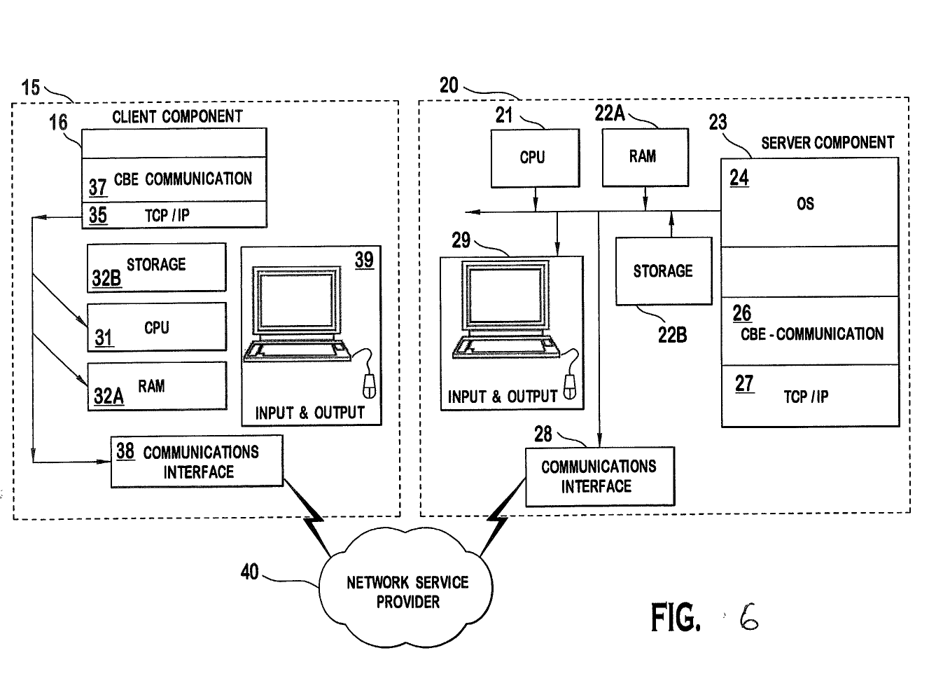

A computer software application may be used to manage the auction. Preferably, as shown in FIG. 6, the software application has two components: a client component 16 and a server component 23. The client component 16 may operate on a computer at the site of each of the potential suppliers 30. Suppliers 30 make bids during the auction using the client component 16. The bids may be sent via the network service provider 40 to the site of the coordinator, where it is received by the server component 23 of the software application. The client component 16 may include software used to make a connection through telephone lines or the Internet to the server component 23. Bids may be submitted over this connection and updates may be sent to the connected suppliers.

Bids may only be submitted using the client component 16 of the application. This ensures that buyers do not circumvent the bidding process, and that only invited suppliers participate in the bidding. Bidders may see their bids and bids placed by other suppliers for each lot on the client component 16. When a bidder submits a bid, that bid is sent to the server component 23 and evaluated to determine whether the bid is from an authorized bidder and whether the bid has exceeded a pre-determined maximum acceptable price. Bids placed by a supplier may be broadcast to all connected bidders, thereby enabling every participating bidder to quickly view the change in market conditions and begin planning their competitive responses.

The embodiments of the invention may be implemented by a processor-based computer system. The system includes a database for receiving and storing a price ceiling and a tolerance from a buyer and a plurality of bids from a plurality of suppliers for a resource and software for validating the bids and generating an optimal solution. The bids have a unit price and a quantity, and the optimal solution has an optimal quantity, an optimal unit price and an optimal parameter.

With reference to FIG. 6, a computer system 20 operates to execute the functionality for server component 23. Computer system 20 includes a processor 21, a memory 22A and a disk storage 22B. Memory 22A stores computer program instructions and data. Processor 21 executes the program instructions or software, and processes the data, stored in memory 22A. Disk storage 22B stores data to be transferred to and from memory 22A. All these elements are interconnected by one or more buses, which allows data to be intercommunicated between the elements.

Processor 21 may be any type of processor capable of providing the speed and functionality required by the embodiments of the invention. For example, processor 21 could be a processor from a family of processors made by Intel Corporation or Motorola.

For purposes of this application, memory 22A and disk 22B are machine readable mediums and could include any medium capable of storing instructions adapted to be executed by a processor. Some examples of such media include, but are not limited to, read-only memory (ROM), random-access memory (RAM), programmable ROM, erasable programmable ROM, electronically erasable programmable ROM, dynamic RAM, magnetic disk (e.g., floppy disk and hard drive), optical disk (e.g., CD-ROM), optical fiber, electrical signals, lightwave signals, radio-frequency (RF) signals and any other device or signal that can store digital information. In one embodiment, the instructions are stored on the medium in a compressed and/or encrypted format. As used herein, the phrase “adapted to be executed by a processor” is meant to encompass instructions stored in a compressed and/or encrypted format, as well as instructions that have to be compiled or installed by an installer before being executed by the processor. Further, system 20 may contain various combinations of machine readable storage devices, which are accessible by processor 21 and which are capable of storing a combination of computer program instructions and data.

Memory 22A is accessible by processor 21 over a bus and includes an operating system, a program partition and a data partition. The program partition stores and allows execution by processor 21 of program instructions that implement the functions of each respective system described herein. The data partition is accessible by processor 21 and stores data used during the execution of program instructions. For some embodiments of the invention, the program partition contains program instructions that performs the buy versus leasing transformation functionality described above.

Computer system 20 also includes input and output devices 29, such as a monitor, printer, mouse, and keyboard, and a network interface 28. Network interface 28 may be any suitable means for controlling communication signals between network devices using a desired set of communications protocols, services and operating procedures. Communication protocols are layered, which is also referred to as a protocol stack, as represented by operating system 24, a CBE-communication layer 26, and a Transport Control Protocol/Internet Protocol (TCP/IP) layer 27. Network interface 28 also includes connectors for connecting interface 28 with a suitable communications medium. Those skilled in the art will understand that network interface 28 may receive communication signals over any suitable medium such as twisted-pair wire, co-axial cable, fiber optics, radio-frequencies, and so forth.

FIG. 6 also shows a computer system 15 that operates to execute the functionality for client component 16. Computer system 15 includes a processor 31, a memory 32A, disk storage 32B, a communications interface 38, input and output devices 39, and a protocol stack having a CBE-communication layer 37 and a TCP/IP layer 35. These elements operate in a manner similar to the corresponding elements for computer system 20.

Another embodiment of the invention includes a machine readable medium for multiple award optimization bidding in online auctions. The machine readable medium includes a first machine readable code that receives and stores a price ceiling and a tolerance from a buyer and a plurality of bids from a plurality of suppliers for a resource, a second machine readable code that validates the bids, and a third readable code that generates an optimal solution. The bids have a unit price and a quantity, and the optimal solution has an optimal quantity, an optimal unit price, and an optimal parameter. A fourth readable code that receives a value for a new unit price or a new quantity, generates an optimal bid using the value, and supplies a corresponding value necessary to reach the optimal bid or a no feasible solution result may also be included.

While the invention has been described in detail and with reference to specific embodiments thereof, it will be apparent to one skilled in the art that various changes and modifications can be made therein without departing from the spirit and scope thereof Thus, it is intended that the present invention covers the modifications and variations of this invention provided they come within the scope of the appended claims and their equivalents.

What is claimed is:

1. A method for multiple award optimization bidding in online auctions comprising:
providing, by the buyer, a price ceiling and a tolerance for a resource;
soliciting a plurality of bids from a plurality of suppliers, the bids having a unit price and a quantity;
validating the bids if the bids meet a set of rules;
generating an optimal solution with the validated bids, the optimal solution having an optimal quantity and an optimal unit price from at least one supplier;
comparing the optimal unit price to a compare value; and
replacing the compare value with the optimal unit price if the optimal unit price is less than the compare value.

2. The method of claim 1 further comprising:
rejecting the bids if the bids do not meet the set of rules; and
denying the bids if at least one of an optimal solution cannot be generated and the optimal unit price is not less than the compare value.

3. The method of claim 1 wherein the validating comprises:
calculating a total cost of each bid;
comparing the unit price for each bid against the price ceiling;
checking the quantity of each bid against a quantity of a previous bid and the total cost of each bid against a previous total cost;
evaluating the quantity of each bid against a quantity of another supplier's bid and the unit price of each bid against a unit price of another supplier's bid; and
rejecting the bid if the bid does not meet the set of rules, the set of rules including the unit price of the bid not being less than the price ceiling, the quantity of the bid not being less than the quantity of a previous bid and the total cost of the bid not being greater than the previous total cost, and the quantity of the bid not being equal to the quantity of at least one other supplier's bid and the unit price of the bid not being equal to the unit price of at least one other supplier's bid.

4. The method of claim 1 wherein the generating comprises:
using non-linear programming to determine a decision variable for each bid;
including each bid having the decision variable that matches an optimal parameter in the optimal solution; and
calculating the optimal unit price and the optimal quantity from the included bids.

5. The method of claim 1 wherein the generating comprises:
minimizing the optimal unit price; and
maximizing the optimal quantity.

6. The method of claim 1 wherein the generating comprises:
assigning a decision variable matching the optimal parameter to a bid from a preferred supplier; and
calculating the optimal solution to include the bid from the preferred supplier.

7. The method of claim 1 wherein the generating comprises:
calculating the optimal solution based upon at least one of a minimum number and maximum number of suppliers chosen by the buyer.

8. The method of claim 1 further comprising:
notifying the suppliers of the bids in the optimal solution; and
refreshing a display of the bids with each new bid.

9. The method of claim 8 wherein the notifying comprises:
displaying a ranked ordering of submitted bids in accordance with the optimal solution.

10. The method of claim 1 wherein the soliciting comprises:
identifying at least one of goods and services to be purchased.

11. The method of claim 1 further comprising:
notifying the bidders that the bids are not accepted if a total quantity calculated from the quantity from all bids does not meet the tolerance.

12. The method of claim 1 further comprising:
allowing the buyer to change the tolerance if at least one of the bids are not validated and the optimal solution is not generated.

13. The method of claim 1 wherein the soliciting comprises:
providing a range of values for at least one of the quantity and the unit price.

14. The method of claim 1 wherein the generating comprises:
calculating the optimal solution based on at least one of payment terms, cost, percentage, lead time, discounts and other parameters that are quantifiable as numbers.

15. The method of claim 1 wherein the generating comprises:
determining, as the optimal solution, a lowest overall optimal solution set of bids; and
providing the optimal quantity and the optimal unit price, the optimal quantity being a sum of quantities from the solution set of bids and the optimal unit price being an average of the unit prices from the solution set of bids.

16. A method for multiple award optimization bidding in online auctions comprising:
providing, by the buyer, a price ceiling and a tolerance for a resource;
soliciting a plurality of bids from a plurality of suppliers, the bids having a unit price, a quantity, and a total cost;
accepting a most recent bid from a bidder;
calculating a total cost for the most recent bid;
comparing the unit price for the most recent bid against the price ceiling;
checking the quantity of the most recent bid against a quantity of a previous bid from the bidder and the total cost of the most recent bid against a previous total cost of the bidder;
evaluating the quantity of the most recent bid against a quantity of another supplier's bid and the unit price of the most recent bid against a unit price of another supplier's bid;
rejecting the bid if at least one of the unit price of the most recent bid is not less than the price ceiling, the quantity of the most recent bid is less than the quantity of the previous bid from the bidder and the total cost of the most recent bid is greater than the previous total cost of the bidder, and the quantity of the most recent bid is equal to the quantity of current bids from at least one other supplier and the unit price of the most recent bid is equal to the unit price of the current bids from at least one other supplier;
determining a decision variable for the current bids and the most recent bid if the most recent bid is not rejected;
generating an optimal solution from a lowest overall optimal solution set of the most recent bid that satisfies an objective function and constraints and the current bids that satisfies an objective function and constraints, the optimal solution having an optimal quantity, an optimal unit price and an optimal parameter, the optimal quantity being a sum of quantities from an optimal solution set of bids, the optimal unit price being an average of the unit price from the solution set of bids;
denying the most recent bid if an optimal solution cannot be generated;
comparing the optimal unit price to a compare value;
evaluating whether the decision variable of the most recent bid matches the optimal parameter;
replacing the compare value with the optimal unit price if the optimal unit price is not equal to the compare value and the decision variable of the most recent bid matches the optimal parameter;
notifying the suppliers, in real time, that the most recent bid is in the optimal solution if the decision variable matches the optimal parameter; and
accepting the most recent bid if the decision variable does not match the optimal parameter.

17. A method for bidders to determine an optimal bid comprising:
providing, by the buyer, a price ceiling and a tolerance for a resource;
receiving at least one bid from a supplier, the bid having a unit price and a quantity;
inputting a value for one of a new unit price and a new quantity;
generating an optimal bid using the inputted value; and
supplying at least one of a corresponding value necessary to reach the optimal bid and a no feasible solution result.

18. The method of claim 17 wherein the tolerance includes a maximum quantity and a minimum quantity and the supplying comprises:
rejecting the value if at least one of the new unit price is greater than the price ceiling, the new quantity is less than the minimum quantity, and the new quantity is greater than the maximum quantity; and
requesting a different value.

19. The method of claim 17 wherein the generating comprises:
using non-linear programming to determine a decision variable that matches an optimal parameter; and
calculating one of an optimal unit price and an optimal quantity.

20. The method of claim 17 wherein the generating comprises:
minimizing the corresponding value if the inputted value is a new unit price; and
maximizing the corresponding value if the inputted value is a new quantity.

21. A system for multiple award optimization bidding in online auctions comprising:
a database for receiving and storing a price ceiling and a tolerance from a buyer and a plurality of bids from a plurality of suppliers for a resource, the bids having a unit price and a quantity; and
software for validating the bids and generating an optimal solution, the optimal solution having an optimal quantity, an optimal unit price and an optimal parameter.

22. The system of claim 21 wherein the tolerance comprises a maximum quantity and a minimum quantity.

23. The system of claim 21 wherein the software compares the optimal unit price to a compare value, and replaces the compare value with the optimal unit price if the optimal unit price is less than the compare value and the optimal parameter matches a constraint.

24. The system of claim 21 wherein the software calculates a total cost of each bid, compares the unit price for each bid against the price ceiling, checks the quantity of each bid against a quantity of a previous bid and the total cost of each bid against a previous total cost, evaluates the quantity of each bid against a quantity of another supplier's bid and the unit price of each bid against a unit price of another supplier's bid, rejects the bid if the bid does not meet a set of rules that include the unit price of the bid not being less than the price ceiling, the quantity of the bid not being less than the quantity of a previous bid and the total cost of the bid not being greater than the previous total cost, and the quantity of the bid not being equal to the quantity of at least one other supplier's bid and the unit price of the bid not being equal to the unit price of at least one other supplier's bid.

25. The system of claim 21 wherein the software receives a value for one of a new unit price and a new quantity, generates an optimal bid using the value, and supplies at least one of a corresponding value necessary to reach the optimal bid and a no feasible solution result.

26. The system of claim 21 wherein the optimal quantity is a sum of quantities from an optimal solution set of bids, the optimal unit price is an average of the unit price from the solution set of bids, and the optimal parameter is a decision variable.

27. A machine readable medium for multiple award optimization bidding in online auctions comprising:
a first machine readable code that receives and stores a price ceiling and a tolerance from a buyer and a plurality of bids from a plurality of suppliers for a resource, the bids having a unit price and a quantity;
a second machine readable code that validates the bids; and
a third readable code that generates an optimal solution, the optimal solution having an optimal quantity, an optimal unit price, and an optimal parameter.

28. The machine readable medium of claim 27 wherein the tolerance comprises a minimum quantity and a maximum quantity.

29. The machine readable medium of claim 27 wherein the optimal solution is generated by minimizing the optimal unit price and number of suppliers and maximizing the optimal quantity.

30. The machine readable medium of claim 27 wherein the optimal quantity is a sum of quantities from a combination of bids, the optimal unit price is an average of the unit price from the combination of bids, and the optimal parameter is a decision variable.

31. The machine readable medium of claim 27 wherein the bids are validated by calculating a total cost of each bid, comparing the unit price for each bid against the price ceiling, checking the quantity of each bid against a quantity of a previous bid and the total cost of each bid against a previous total cost, evaluating the quantity of each bid against a quantity of another supplier's bid and the unit price of each bid against a unit price of another supplier's bid and rejecting the bid if the bid does not meet the set of rules, including the unit price of the bid not being less than the price ceiling, the quantity of the bid not being less than the quantity of a previous bid and the total cost of the bid not being greater than the previous total cost, and the quantity of the bid not being equal to the quantity of at least one other supplier's bid and the unit price of the bid not being equal to the unit price of at least one other supplier's bid.

32. The machine readable medium of claim 27 further comprising a fourth readable code that receives a value for one of a new unit price and a new quantity, generates an optimal bid using the value, and supplies at least one of a corresponding value necessary to reach the optimal bid and a no feasible solution result.
